(19) United States
(12) Patent Application Publication
(10) Pub. No.: US 2005/0100629 A1
(43) Pub. Date: May 12, 2005

(54) Nozzle of injection molding machine

(76) Inventors: Shigeru Takai, Numazu-shi (JP); Shinji Watanabe, Numazu-shi (JP)

Correspondence Address: PIPER RUDNICK LLP, P. O. BOX 9271, RESTON, VA, 20195, US

(21) Appl. No.: 10/981,786

(22) Filed: Nov. 5, 2004

(30) Foreign Application Priority Data
Nov. 6, 2003 (JP) 2003-377064

(51) Int. Cl. B29C 45/23

(52) U.S. Cl. 425/564; 425/573

(57) ABSTRACT

A first passage and a second passage are formed in a nozzle body. An inner nozzle is set in a nozzle tip. The inner nozzle can be selected from a plurality of components of which the inside passages have different shapes. A first inner nozzle has a third passage and a fourth passage. The third passage is an annular passage, which surrounds a central axis and opens into a front chamber. The fourth passage is a bore-shaped passage, which extends along the central axis and opens into the front chamber. The third passage joins the fourth passage in a position just short of a discharge port. A second inner nozzle has a bore-shaped fifth passage, which extends along the central axis, and a sixth passage, which joins a midway of the fifth passage at its downstream-side end portion.

### CROSS-REFERENCE TO RELATED APPLICATIONS

This application is based upon and claims the benefit of priority from prior Japanese Patent Application No. 2003-377064, filed Nov. 6, 2003, the entire contents of which are incorporated herein by reference.

### BACKGROUND OF THE INVENTION

1. Field of the Invention

The present invention relates to a nozzle of an injection molding machine, and more particularly, to a nozzle employed in injection molding using resins of two different compositions or colors, such as sandwich molding, mixed molding, etc.

2. Description of the Related Art

Conventionally, there have been widely used molded resin products of a multilayer structure in which a resin for core is covered by a resin for skin. Injection molding machines of various constructions for manufacturing these molded resin products have been proposed in Jpn. Pat. Appln. KOKAI Publications Nos. 01-141711, 10-151645, and 2003-053783, for example.

Since an injection molding machine that is employed in sandwich molding or mixed molding must be provided with two injection units, it requires a huge investment in equipment. It is essential, therefore, to ensure effective use of the injection molding machine in various molding modes, in order to reduce the manufacturing costs of molded products or quickly meet diverse demands.

A system is already known in which the molding mode is switched between sandwich molding and mixed molding by replacing an entire nozzle with a new one. According to this arrangement, however, switching the molding mode requires replacement of many components, so that spare parts to be provided in advance entail considerable costs. This constitutes a hindrance to the adoption of this system.

### BRIEF SUMMARY OF THE INVENTION

The present invention has been made in consideration of the above drawback of the conventional injection molding machine, and its object is to provide a nozzle of an injection molding machine, capable of dealing with various types of injection molding, such as sandwich molding, mixed molding, etc., using resins of two different compositions or colors.

A nozzle of an injection molding machine according to the invention is a nozzle which is employed in injection molding using first and second resins. The nozzle comprises a nozzle body which has a first passage in the form of a bore extending along a central axis thereof and opening in a rear end face of the nozzle body, and a second passage in the form of a bore adjacent to the first passage and opening near a rear end portion of the nozzle body; a nozzle tip mounted on a distal end of the nozzle body; and an inner nozzle set in the nozzle tip and having therein passages through which the first and second resins flow, individually. The nozzle tip has a discharge port, a front chamber formed on the upstream side of the discharge port, and a socket portion formed behind the front chamber and fitted with the inner nozzle. The inner nozzle to be attached to the socket portion can be selected from a plurality of inner nozzles of which the inside passages have different shapes. A first inner nozzle, out of said plurality of inner nozzles, has a third passage and a fourth passage, the third passage being linked to the first passage at an upstream-side end thereof and forming an annular passage which surrounds the central axis at a downstream-side end portion thereof and opening into the front chamber, the fourth passage being linked to the second passage at an upstream-side end thereof and forming a bore-shaped passage which extends along the central axis at a downstream-side end portion thereof and opening into the front chamber. A second inner nozzle, out of said plurality of inner nozzles, has a fifth passage and a sixth passage, the fifth passage forming a bore-shaped passage which extends along the central axis and is linked to the first passage at upstream-side end thereof and linked to the front chamber at downstream-side end thereof, the sixth passage being linked to the second passage at an upstream-side end thereof and joining a midway of the fifth passage at a downstream-side end portion thereof.

If injection molding is performed with the first inner nozzle set in the nozzle tip, in the nozzle of an injection molding machine according to the invention, the first resin flows from the first passage into the front chamber through the third passage and advances along the inner periphery of the front chamber to the discharge port. The second resin flows from the second passage into the front chamber through the fourth passage and advances to the discharge port via a central portion of the front chamber. Thus, sandwich molding can be achieved by suitably adjusting injection timings for the first and second resins.

If injection molding is performed with the second inner nozzle set in the nozzle tip, on the other hand, the first resin flows from the first passage into the front chamber through the fifth passage and reaches the discharge port via the front chamber. The second resin flows from the second passage to a midway of the fifth passage through the sixth passage. It is partially mixed with the first resin as it enters the front chamber and reaches the discharge port via the front chamber. Thus, mixed molding can be achieved by suitably adjusting injection timings for the first and second resins.

According to the nozzle of an injection molding machine of the invention, the molding mode can be easily switched between multilayer molding such as sandwich molding, and mixed molding such as marble molding, merely by changing the inner nozzle. Further, detailed conditions, such as differences in patterns, may be changed even for similar types of multilayer or mixed molding. Furthermore, the nozzle can deal with large-capacity injection molding of a single type (one-resin type).

Preferably, the first inner nozzle has on the distal end thereof a protrusion which projects into the front chamber and defines an annular space in conjunction with an inner peripheral surface of the front chamber, the third passage is linked to the first pass-age at the upstream-side end thereof and forms the annular passage which surrounds the central axis at the downstream-side end portion thereof and opens into the front chamber, and the fourth passage is linked to the second passage at the upstream-side end thereof and forms the bore-shaped passage which extends along the central axis at the downstream-side end portion thereof and opens into the front chamber, thereby joining the third passage in a position just short of the discharge port.

If the first inner nozzle is shaped in this manner, a first molten resin enters the front chamber through the first and third passages and via the outer periphery of a core of the inner nozzle and is injected through the discharge port. A second molten resin enters the front chamber through the second and fourth passages and via the center of the core of the inner nozzle and is injected through the discharge port.

Preferably, in the nozzle of an injection molding machine, the first passage of the nozzle body is a bore-shaped passage which is formed on the central axis and opens in the rear end face of the nozzle body, and the second passage of the nozzle body is formed extending parallel to the central axis, bends away from the central axis at a point near the rear end portion of the nozzle body, and opens in a side face of the nozzle body.

Preferably, the nozzle of an injection molding machine further comprises a connecting block which is connected to the side face of the nozzle body and connects the second passage with an injection unit for supplying a molten resin to the second passage, and a shut-off valve which is provided in the middle of a passage in the connecting block and/or the first passage and serves to open and close the passage.

Thus, by providing the shut-off valve in the middle of the first passage and/or on the upstream side of the second passage, one of the resins can be prevented from being unexpectedly mixed into the other resin, so that the quality of molded products can be improved.

The nozzle of an injection molding machine according to the invention can deal with various types of injection molding using resins of two different compositions or colors, or with large-capacity injection molding using a single resin. With use of the nozzle of the invention, the molding mode can be easily changed merely by replacing the inner nozzle with a new one. Thus, a wide variety of orders can be quickly accepted, and the manufacturing costs of molded products can be reduced.

### BRIEF DESCRIPTION OF THE SEVERAL VIEWS OF THE DRAWING

FIG. 1 is a view showing a first embodiment of a nozzle of an injection molding machine according to the present invention;

FIG. 2 is a sectional view taken along line A-A of FIG. 1;

FIG. 3 is an enlarged sectional view showing a part of the nozzle shown in FIG. 1 near its distal end;

FIG. 4 is a sectional view taken along line B-B of FIG. 3;

FIG. 5 is a view showing a second embodiment of the nozzle of an injection molding machine according to the invention;

FIG. 6 is an enlarged sectional view showing a part of the nozzle shown in FIG. 5 near its distal end; and

FIG. 7 is a view showing another example of the nozzle of an injection molding machine according to the invention.

### DETAILED DESCRIPTION OF THE INVENTION

### Embodiment 1

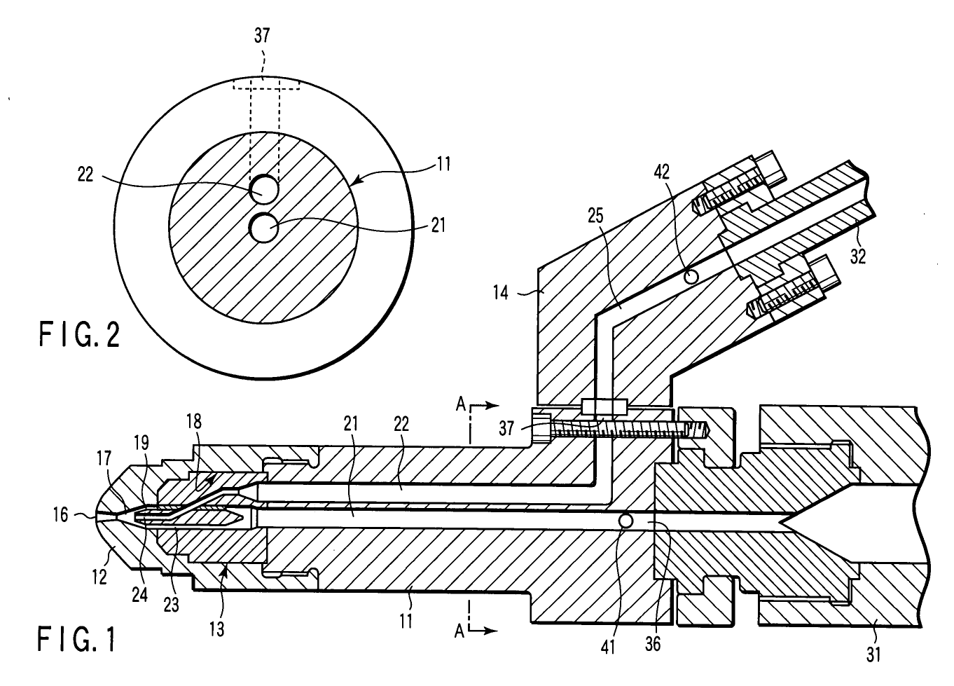

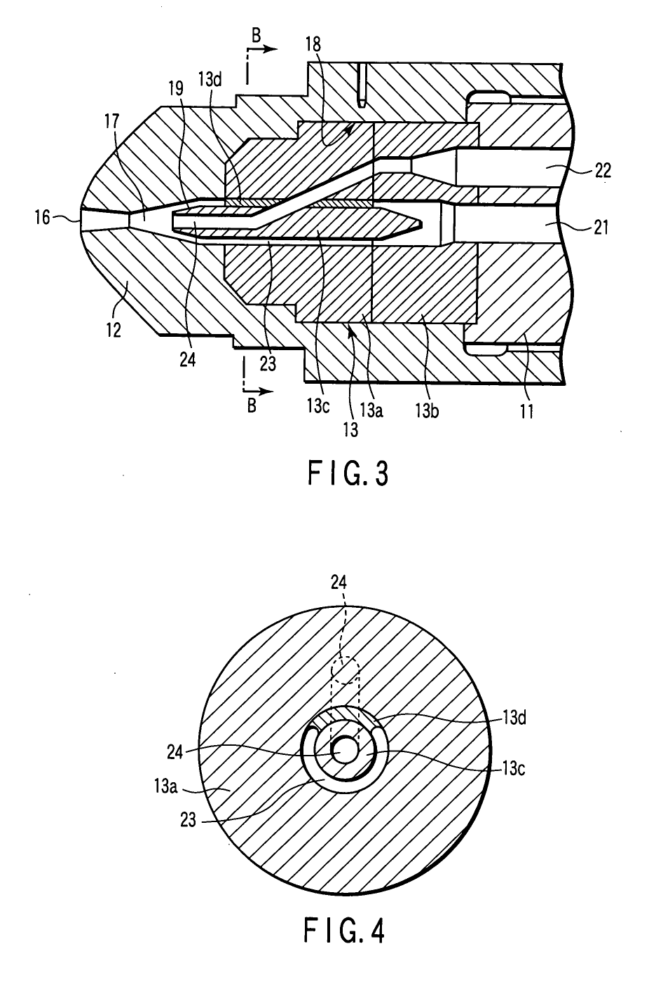

FIG. 1 shows a first embodiment of a nozzle of an injection molding machine according to the present invention. This example represents a state in which a first inner nozzle is set in place. FIG. 2 is a sectional view taken along line A-A of FIG. 1. FIG. 3 is an enlarged sectional view showing a part of the nozzle near its distal end. FIG. 4 is a sectional view taken along line B-B of FIG. 3. In these drawings, numeral 11 denotes a nozzle body; 12, a nozzle tip; 13, the first inner nozzle; 16, a discharge port; 17, a front chamber; 18, a socket portion; 19, a protrusion; 21, a first passage; 22, a second passage; 23, a third passage; and 24, a fourth passage.

In this example, the nozzle of an injection molding machine comprises the nozzle body 11, the nozzle tip 12, the first inner nozzle 13, a connecting block 14, etc. The nozzle tip 12 is mounted on the distal end of the nozzle body 11, and the first inner nozzle 13 is set in the tip 12.

As shown in FIGS. 1 and 2, two independent passages (first and second passages 21 and 22) are defined in the nozzle body 11. The first passage 21 is in the form of a bore that penetrates the body 11 along its central axis. One end of the passage 21 opens in the rear end face of the body 11 to form a first port 36. The second passage 22 is in the form of a bore that extends parallel to the first passage 21. The second passage 22 bends away from the first passage 21 at a point near the rear end portion of the body 11. The upstream-side end of the passage 22 opens in the side face of the body 11 to form a second port 37. A first injection unit 31 is connected to the rear end face of the body 11. A second injection unit 32 is connected by the connecting block 14 to that part of the side face of the body 11 near its rear end portion.

The nozzle tip 12 has the discharge port 16, and the front chamber 17 is formed on an upstream side of the port 16. The socket portion 18 is formed behind the front chamber 17. The first inner nozzle 13 is set in the socket portion 18.

As shown in FIGS. 3 and 4, the first inner nozzle 13 is formed as an integral part that includes a first outer cylinder 13a, second outer cylinder 13b, core 13c, and support leg 13d. The second outer cylinder 13b is connected to the rear end portion of the first outer cylinder 13a. A through hole is formed extending along the central axis of the first and second outer cylinders 13a and 13b. The core 13c is in the form of a spindle that is connected to the inside of the first outer cylinder 13a by the support leg 13d. The distal end portion (protrusion 19) of the core 13c projects from the front end face of the first outer cylinder 13a into the front chamber 17. An annular passage is defined between the outer peripheral surface of the core 13c and the inner peripheral surface of the through hole. An annular space is also defined between the outer peripheral surface of the distal end portion of the core 13c and the inner peripheral surface of the front chamber 17 so as to be continuous with the annular passage.

Two independent passages (third and fourth passages 23 and 24) are defined in the first inner nozzle 13. The third passage 23 is linked to the first passage 21 on the rear end face of the second outer cylinder 13b. It extends along the central axis of the cylinder 13b and forms the aforesaid annular passage, which extends outside the core 13c in a position near the rear end face of the first outer cylinder 13a and opens into the front chamber 17. The fourth passage 24 is linked to the second passage 22 on the rear end face of the second outer cylinder 13b. It obliquely bends in the middle of the second outer cylinder 13b, diagonally penetrates the first outer cylinder 13a and the support leg 13d, and reaches the center of the core 13c. Then, the fourth passage 24 extends along the central axis and opens into the front chamber 17 at the distal end of the protrusion 19. Thus, the third passage 23 extends through the annular space outside the distal end portion of the core 13c and joins the fourth passage 24 in a position just short of the discharge port 16.

In this example, a shut-off valve 41 is inserted in the middle of the first passage 21 in a position near the first port 36. A shut-off valve 42 is also inserted in the middle of a passage 25 that is defined in the connecting block 14.

A resin for skin is delivered from the first injection unit 31 into the nozzle through the first port 36. Then, it enters the front chamber 17 through the shut-off valve 41 and the first and third passages 21 and 23 and is injected into dies (not shown) through the discharge port 16. On the other hand, a resin for core is delivered from the second injection unit 32 into the nozzle through the passage 25 in the connecting block 14 and via the shut-off valve 42 in the middle and the second port 37. Then, it enters the front chamber 17 through the second and fourth passages 22 and 24 and is injected into the dies through the discharge port 16.

The following is a description of an example of a procedure for sandwich molding using the nozzle.

First, the first injection unit 31 is actuated to inject the resin for skin through the discharge port 16 into the dies via the first port 36 and the first and third passages 21 and 23. As this is done, the motion of a screw of the second injection unit 32 is restricted by blocking back pressure (or by locking a screw driving motor). Since the shut-off valve 42 is closed, moreover, the resin is prevented from flowing backward. However, an amount of the resin for skin corresponding to its compression flows into a region near the outlet of the fourth passage 24.

After a predetermined amount of the resin for skin is injected, the operation of the first injection unit 31 is stopped, and the second injection unit 32 is actuated to inject the resin for core into the dies through the connecting block 14, second port 37, second and fourth passages 22 and 24, and discharge port 16.

The operation of the second injection unit 32 is stopped immediately before the filling is completed. Then, the first injection unit 31 is actuated again to inject only the resin for skin, whereupon the injection process is terminated. Thus, a molded sandwich product can be obtained of which the entire surface is covered by the resin for skin. By this operation, moreover, the resin for core having so far been flowing backward near the outlet of the third passage 23, along with the resin for core layer remaining in the front chamber 17, can be delivered into the dies. In this manner, the resin in the front chamber 17 can be completely replaced with the resin for skin to provide for the next injection cycle.

The nozzle may be used to perform sandwich molding with the resin for skin and the resin for core in reciprocal combination, alternatively.

More specifically, the second injection unit 32 is first actuated to inject the resin for skin through the discharge port 16 into the dies via the second port 37 and the second and fourth passages 22 and 24. As this is done, the motion of a screw of the first injection unit 31 is restricted by blocking back pressure (or by locking the screw driving motor). Since the shut-off valve 41 is closed, moreover, the resin is prevented from flowing backward. However, an amount of the resin for skin corresponding to its compression flows into a region near the outlet of the annular third passage 23.

After a necessary amount of the resin for skin is injected, the injection speed of the second injection unit 32 is lowered, and the first injection unit 31 is actuated to inject the resin for core into the dies through the first port 36, first and third passages 21 and 23, and discharge port 16. The operation of the first injection unit 31 is stopped immediately before the filling is completed, and only the resin for skin is injected. Thus, a molded product is completed of which the entire surface is covered by the resin for skin.

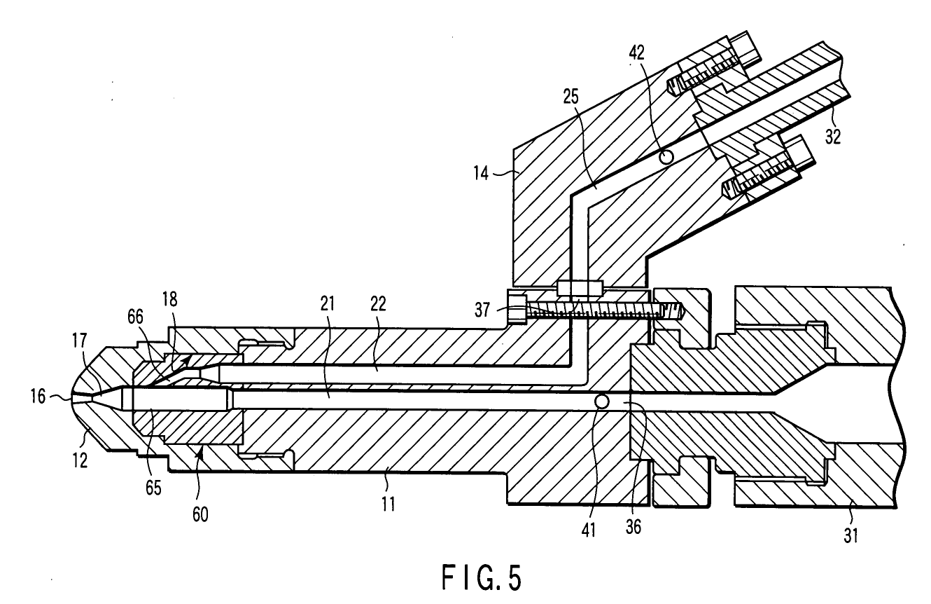

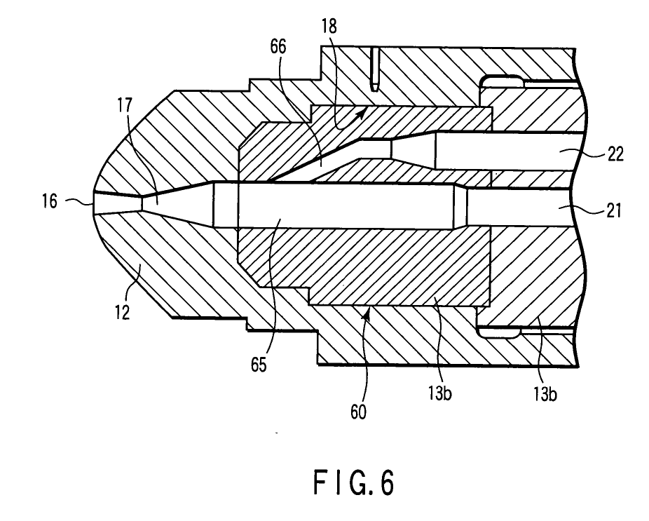

FIG. 5 shows a second embodiment of the nozzle of an injection molding machine according to the present invention. This example represents a state in which a second inner nozzle is set in place. FIG. 6 is an enlarged sectional view showing a part of the nozzle near its distal end. In these drawings, numeral 11 denotes a nozzle body; 12, a nozzle tip; 60, the second inner nozzle; 16, a discharge port; 17, a front chamber; 18, a socket portion; 21, a first passage; 22, a second passage; 65, a fifth passage; and 66, a sixth passage.

This embodiment differs from the embodiment shown in FIG. 1 in that only the first inner nozzle 13 is removed and replaced with the second inner nozzle 60. Therefore, the nozzle body 11, nozzle tip 12, etc. are identical with their counterparts shown in FIG. 1.

As shown in the enlarged sectional view of FIG. 6, the two passages (fifth and sixth passages 65 and 66) are defined in the second inner nozzle 60. The fifth passage 65 extends along the central axis of the second inner nozzle 60. It is linked to the first passage 21 on the rear end face of the nozzle 60 and opens into the front chamber 17 through the distal end face. The sixth passage 66 is linked to the second passage 22 on the rear end face of the second inner nozzle 60 and then forwardly advances parallel to the fifth passage 65. Then, it obliquely bends in the middle and joins a midway of the fifth passage 65 near the distal end portion of the second inner nozzle 60.

A first resin is delivered from the first injection unit 31 into the nozzle through the first port 36. Then, it enters the front chamber 17 through the shut-off valve 41 and the first and fifth passages 21 and 65 and is injected into the dies (not shown) through the discharge port 16. On the other hand, a second resin is delivered from the second injection unit 32 into the nozzle through the passage 25 in the connecting block 14 and via the shut-off valve 42 in the middle and the second port 37. Then, it enters a midway of the fifth passage 65 through the second and sixth passages 22 and 66 and is injected into the dies through the front chamber 17 and the discharge port 16.

Thus, various types of mixed molding can be achieved by suitably adjusting injection timings for the first and second resins.

In the examples described above, the nozzle tips 12 have a common shape. If only the shape of a junction with the nozzle body 11 is designed for common use, however, the shapes of other parts may be suitably changed depending on the shape of the inner nozzle.

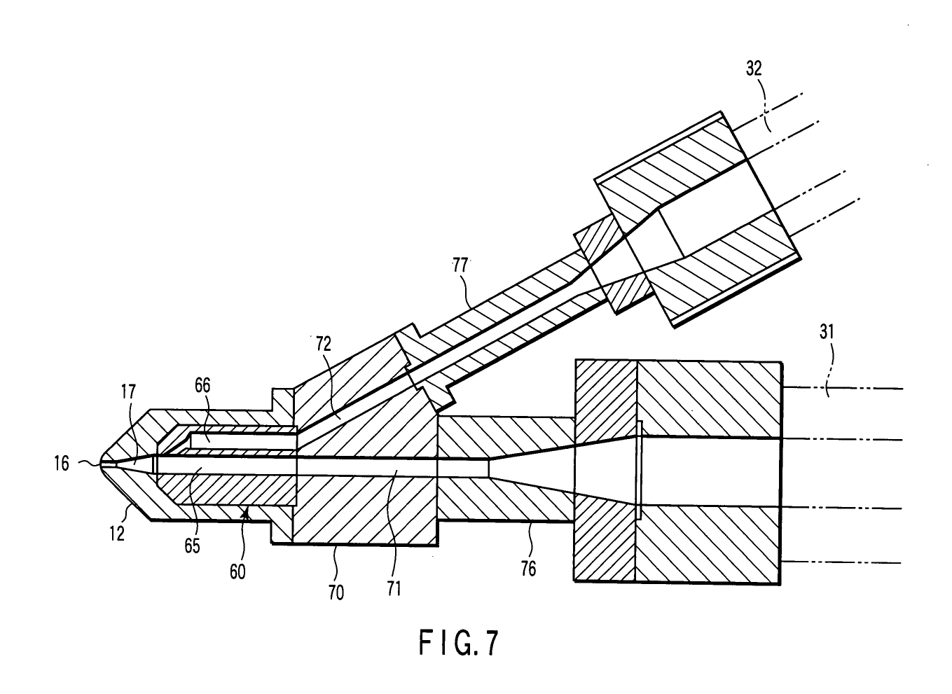

FIG. 7 shows another example of the nozzle of an injection molding machine according to the present invention. In the foregoing example (FIG. 1), the second passage 22 is located parallel to the nozzle axis (except for a region near the upstream-side end), and its upstream-side end opens in the side face of the nozzle body 11. In this example, however, a second passage 72 is formed extending obliquely to the nozzle axis. The upstream-side end of the second passage 72 opens obliquely to the nozzle axis, in a position near the rear end face of a nozzle body 70. A first passage 71 is connected to a first injection unit 31 by a connecting block 76, while the second passage 72 is connected to a second injection unit 32 by a connecting block 77.

Although a nozzle tip 12 and a second inner nozzle 60 (second inner nozzle) are different in shape from the ones shown in FIG. 1 or 5, their internal passages share their functions in common. Further, the second inner nozzle 60 shown in FIG. 7 is of the same type as the second inner nozzle 60 shown in FIGS. 5 and 6. However, it may be replaced with a new one that is of the same type as the first inner nozzle 13 shown in FIGS. 1 and 3.

1. A nozzle of an injection molding machine, which is employed in injection molding using first and second resins, comprising:
a nozzle body which has a first passage in the form of a bore extending along a central axis thereof and opening in a rear end face of the nozzle body, and a second passage in the form of a bore adjacent to the first passage and opening near a rear end portion of the nozzle body;
a nozzle tip mounted on a distal end of the nozzle body; and
an inner nozzle set in the nozzle tip and having therein passages through which the first and second resins flow, individually, wherein
the nozzle tip has a discharge port, a front chamber formed on the upstream side of the discharge port, and a socket portion formed behind the front chamber and fitted with the inner nozzle,
the inner nozzle to be attached to the socket portion can be selected from a plurality of inner nozzles of which the inside passages have different shapes,
a first inner nozzle, out of said plurality of inner nozzles, has a third passage and a fourth passage, the third passage being linked to the first passage at an upstream-side end thereof and forming an annular passage which surrounds the central axis at a downstream-side end portion thereof and opening into the front chamber, the fourth passage being linked to the second passage at an upstream-side end thereof and forming a bore-shaped passage which extends along the central axis at a downstream-side end portion thereof and opening into the front chamber, and
a second inner nozzle, out of said plurality of inner nozzles, has a fifth passage and a sixth passage, the fifth passage forming a bore-shaped passage which extends along the central axis and is linked to the first passage at upstream-side end thereof and linked to the front chamber at downstream-side end thereof, the sixth passage being linked to the second passage at an upstream-side end thereof and joining a midway of the fifth passage at a downstream-side end portion thereof.

2. A nozzle of an injection molding machine according to claim 1, wherein the first inner nozzle has on the distal end thereof a protrusion which projects into the front chamber and defines an annular space in conjunction with an inner peripheral surface of the front chamber, the third passage is linked to the first passage at the upstream-side end thereof and forms the annular passage which surrounds the central axis at the downstream-side end portion thereof and opens into the front chamber, and the fourth passage is linked to the second passage at the upstream-side end thereof and forms the bore-shaped passage which extends along the central axis at the downstream-side end portion thereof and opens into the front chamber, thereby joining the third passage in a position just short of the discharge port.

3. A nozzle of an injection molding machine according to claim 1, wherein the first passage of the nozzle body is a bore-shaped passage which is formed on the central axis and opens in the rear end face of the nozzle body, and the second passage of the nozzle body is formed extending parallel to the central axis, bends away from the central axis at a point near the rear end portion of the nozzle body, and opens in a side face of the nozzle body.

4. A nozzle of an injection molding machine according to claim 3, further comprising
a connecting block which is connected to the side face of the nozzle body and connects the second passage with an injection unit for supplying a molten resin to the second passage; and
a shut-off valve which is provided in the middle of a passage in the connecting block and/or the first passage and serves to open and close the passage.
